(19) United States
(12) Patent Application Publication
(10) Pub. No.: US 2007/0271526 A1
(43) Pub. Date: Nov. 22, 2007

(54) User Interface Paradigm for Manufacturing Applications

(76) Inventor: John Jay POWLEY, Plainville, MA (US)

Correspondence Address: GENERAL ELECTRIC CO.;GLOBAL PATENT OPERATION, 187 Danbury Road, Suite 204, Wilton, CT, 06897-4122, US

(21) Appl. No.: 11/419,690

(22) Filed: May 22, 2006

(51) Int. Cl. G06F 3/00

(52) U.S. Cl. 715/810

(57) ABSTRACT

A user interface (UI) for manufacturing applications employs a paradigm having a single progression for displaying manufacturing system information regardless of the point of view of the user. The UI includes a series of functional and information selections which occur in a smoothly flowing selection path within the UI which is easily and intuitively followed by a user. Information corresponding to the user selections in the selection path is displayed in a main display area of the UI.

### BACKGROUND OF THE INVENTION

The field of the invention relates to user interfaces for manufacturing applications.

Manufacturing applications are used for controlling and monitoring processes. Applications built using current developer frameworks, such as Visual Studios from Microsoft or Eclipse from Eclipse Foundation, leverage common controls to provide a user interface (UI). Typically, a workspace or workbench environment is presented to the user to interact with the software application. These types of environments utilize a graphical tree control to organize and present data to a user wherein the user can select an item of interest. A tree control system is similar to a folder system in which all items have a parent object and all may have child objects forming branches that can be expanded and collapsed to view or hide features for selection. A UI having a tree system is illustrated in FIG. 5 of U.S. Pat. No. 7,039,632, for example. Tree control software systems then present menus within the selected item for selecting an operation. The operation is then displayed in a frame of the UI adjacent the tree display.

Tree control systems suffer from the problem that as selections in a branch are made by continuously expanding levels of the branch to make finer selections, the context of the branch is often lost due to the size of the UI display frame containing the tree. Similarly, operations specific to the selected context are lost because all of the menus are still present while working in the application. At the same time, there is no indication of what data is being operated upon for display in the UI display frame. Tree control systems also fail to provide operational workflow paradigms which reflect task activity of users; the systems are arranged and organized according to a programmer's concept of relationships between items for selection relative to a top level process. Finally, software UI's like tree control systems effectively drive the user interaction instead of allowing the user to drive the UI software interaction.

Accordingly, a need exists for a new user interface incorporating a paradigm which overcomes the problems noted above and enhances the overall user experience.

### BRIEF DESCRIPTION OF THE INVENTION

A user interface (UI) for manufacturing applications employs a paradigm having a single progression for displaying manufacturing system information regardless of the functional point of view of the user. The UI includes a series of functional and information selections which occur in a smoothly flowing selection path within the UI which is easily and intuitively followed by a user. A user first uses a primary focus area of the UI to select a function to operate upon in the UI. The next portion of the selection path is formed by lens components. The lens components provide sequentially narrowing areas of potential interest, or operations, to users. The operations are organized under each function available for selection. The lens components are arranged to flow from the primary focus area and sequentially focus the area of interest through a hierarchy or web of user selections. The choices in the lens components remain visible throughout the selection and operation process. Once sufficient selections are made via the lens components, the main display area displays information or provides a window for software applications to operate which are based upon the user choices and selections in the lens components. The UI simplifies the navigation to particular items of interest and the lens components provide immediate and visible access to the operations that can be performed on the selected items.

In a further embodiment of the invention, a visualization selection region is provided in which options for viewing the selection made with the lens components can be chosen. Display options can include, reports, configuration information and operating status, among others.

In a still further embodiment of the invention, the display area can include active portions, that when selected, generate pop-up windows for taking action on the element associated with the active portion. Alternately, the pop-up window may be used to permit access to other applications or information. Meanwhile, the display area retains the display of the selected items of interest.

The various features of novelty which characterize the invention are pointed out with particularity in the claims annexed to and forming a part of this disclosure. For a better understanding of the invention, its operating advantages and benefits obtained by its uses, reference is made to the accompanying drawings and descriptive matter. The accompanying drawings are intended to show examples of the many forms of the invention. The drawings are not intended as showing the limits of all of the ways the invention can be made and used. Changes to and substitutions of the various components of the invention can of course be made. The invention resides as well in sub-combinations and sub-systems of the elements described, and in methods of using them.

### BRIEF DESCRIPTION OF THE DRAWINGS

FIG. 1 is a representation of a user interface in accordance with one embodiment; and

FIG. 2 is a diagram of the user interface of FIG. 1 showing the flow of decision-making through the user interface.

### DETAILED DESCRIPTION OF THE INVENTION

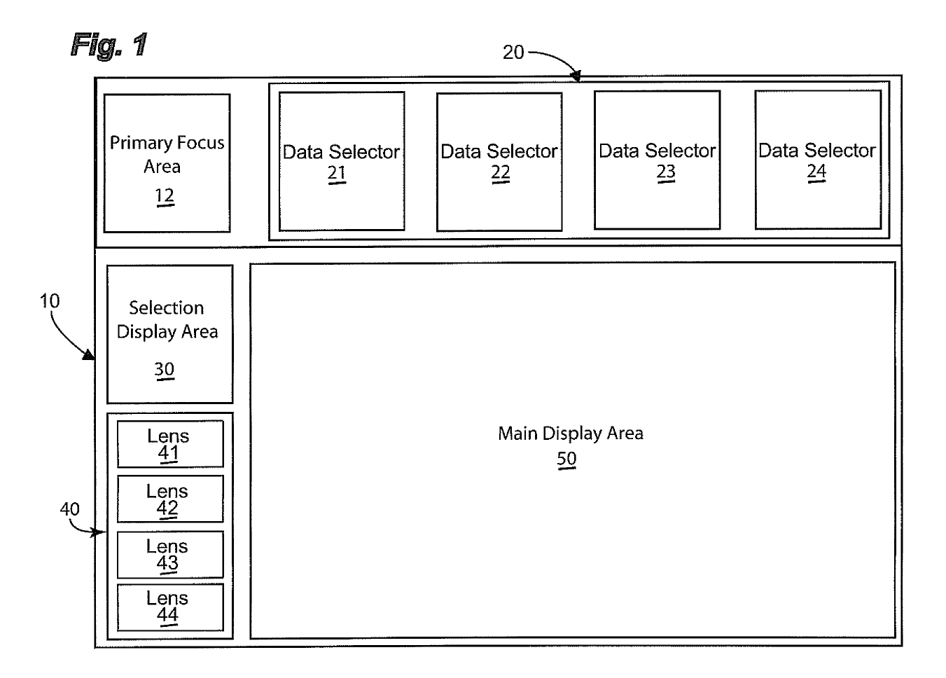

Referring now to the drawings in which like reference numerals are used to indicate the same or related elements, FIG. 1 illustrates a user interface (UI) 10 having a primary focus area 12, subordinate focus region 20 with data selectors 21, 22, 23, 24, selection display area 30, display option region 40 with lens components 41, 42, 43, 44, and main display area 50. The UI 10 provides a paradigm for smoothly and intuitively passing from user selection to user selection to display the desired information while retaining information about the context in which the information is provided.

The UI 10 generally organizes available information in terms of function. For example, in manufacturing applications, users interested in configuration functions of the user interface 10 can include system integrators and engineers and technicians who use the UI 10 to build a virtual plant being controlled by the application and set up solutions for the application. Users who rely on run-time information include managers and analysts, who use the UI 10 for analyzing reports on the status of the process being controlled and/or monitored by the manufacturing application, and operators who run the facility and use the UI 10 to monitor equipment and respond to alarms.

Primary focus area 12 contains several functional solutions for selection. The available solutions are based upon the functions the manufacturing application is used to control and/or monitor. Functions can include, for example, OEE, CAPA or the configuration of the plant model, among others. The functional solutions are designed to fit the operators of the system and the remaining selections within the UI 10 are based upon the initial selection using the primary focus area 12.

Once a user has determined which functional solution they want to obtain more information using the primary focus are 12, the subordinate focus area 20 populates with available sub-selections in the data selector component windows 21, 22, 23, 24. It should be noted that while four data selectors are shown, it is possible to have as few as one or two data selectors and, alternatively, many more than just four data selectors 21, 22, 23, 24. The number of data selectors 21, 22, 23, 24 is determined by the number of selections within a functional area selected using primary focus area 12. The data selectors 21, 22, 23, 24 of the subordinate focus area 20 are used to sequentially select particular assets or other information of interest about a plant being controlled and/or monitored by the manufacturing application. The data selectors 21, 22, 23, 24 effectively provide the selections like a tree view, but without losing context in a manner that a user can easily refer back to a prior data selectors 21, 22, 23, 24 to clearly see what choices were made.

Once a final sub-selection is made with the data selectors 21, 22, 23, 24, the selection is displayed in selection display area 30 to remind the user of the UI 10 what is the particular item that was chosen. Below selection display area 30, visualization selection region 40 is provided which contains choices for viewing the selected item shown in selection display area 30. The choices are made in visualization selection region 40 using lens components 41, 42, 43, 44. The lens components 41, 42, 43, 44 allow the user to identify and focus upon the particular display. The visualization choices can include status information, configuration details and reports, such as operating statistics, efficiency, and maintenance records, among other things. When a visualization choice is made in visualization selection region 40 using lens components 41, 42, 43, 44, then display area 50 is populated with the selected visualization for the selected item. The display area 50 is preferably a large percentage of the UI 10 screen area so that the selected item is shown in the greatest available space. Further, while the selected item is being shown in the display area 50, the primary focus area 12, data selectors 21, 22, 23, 24, selection display area 30 and visualization selection region 40 all continue to clearly display the user selections, so that context of the solution item displayed is not lost.

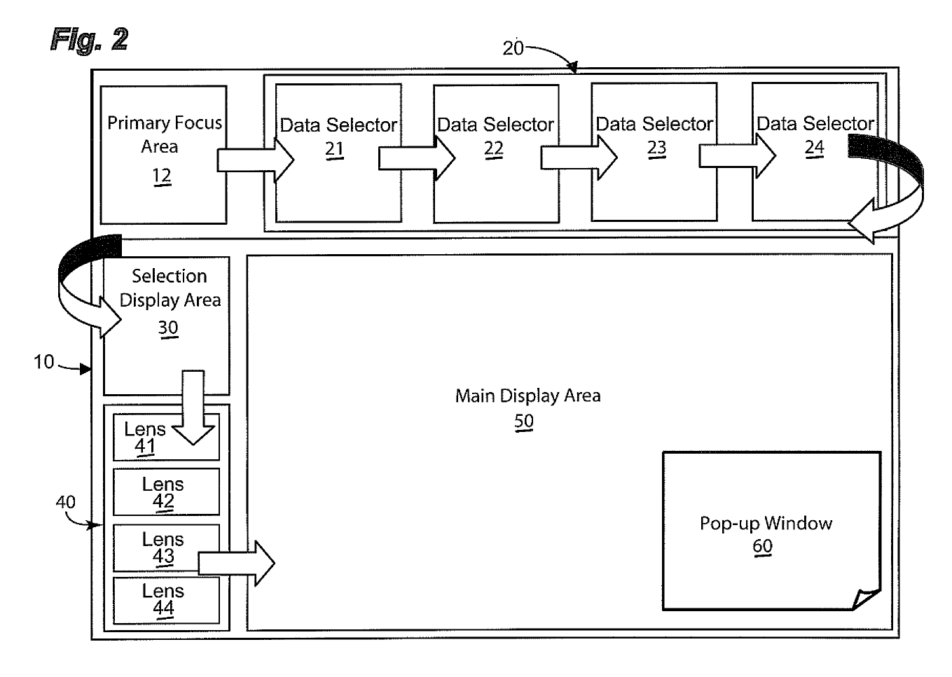

Referring now to FIG. 2, the flow between sections of UI 10 is illustrated by the several arrows. The flow between sections provides a paradigm which is easily accepted and intuitive to most users. As can be seen, a user of the UI 10 initiates the selection process in the upper left hand corner by making their functional selection in primary focus area 12. Then, the subordinate focus region 20 is located adjacent to the primary focus area 12 in a linear alignment, so that the user sequentially moves from left to right from the primary focus area 12 to each of the data selector components 21, 22, 23, 24 present to make their selections.

Once a final selection is made using the subordinate focus region 20, the user's attention is returned to the left side of the UI 10 to the selection display area 30 and visualization selection region 40. The selection display area 30 provides a reminder of the particular item selection that was made in a space that is adjacent to both the visualization selection region 40 and the display area 50. The user's desired item selection is thus easy to find, while, by referring back to the navigation panel formed by the primary focus area 12 and subordinate focus region 20, the user quickly sees the context of the item selection. The display area 50 is the primary focus of the UI 10, with the navigation panel 12, 20 and selection and visualization choices 30, 40 surrounding the display area 50 in an arrangement which is intuitive to navigate. The user can quickly use the lens components 41, 42, 43, 44 to change the form of the display in display area 50 while retaining the context of the display with selection display are and navigation panel 12,20.

In a further embodiment of the invention illustrated in FIG. 2, display area 50 may contain active regions which generate pop-up windows 60 for action on an element in the display or for obtaining information external to the manufacturing application.

The UI 10 advantageously allows adaptation to ever-increasing data spaces, as the user is always aware of the context in which the display in display area 50 is presented based on the navigation panel 12, 20 and visualization selection area 40 choices in the form of lens components 41, 42, 43, 44 being visible surrounding the display area 50. The context is not lost when actions are performed on elements of the display area, since those are done via pop-up windows 60.

While the present embodiment has been described with references to preferred embodiments, various changes or substitutions may be made on these embodiments by those ordinarily skilled in the art pertinent to the present embodiment with out departing from the technical scope of the present embodiment. Therefore, the technical scope of the present embodiment encompasses not only those embodiments described above, but all that fall within the scope of the appended claims.

What is claimed is:

1. A user interface for a manufacturing application, comprising:
a primary focus area containing at least two functional solutions for selection by a user;
a subordinate focus region having at least two data selectors for selecting sub-components of each of the at least two functional solutions to define a selected item, the lens components and primary focus area being arranged linear and sequential;
a selection display area displaying the selected item;
a visualization selection region containing lens components identifying display options for viewing the selected item; and
a display area in which the selected item is displayed according to the display option chosen in the visualization selection region, the selection display area and visualization selection region being arranged adjacent to the display area and the display area being larger than any other area or region.

2. A user interface according to claim 1, wherein the at least two data selectors have sequentially narrower subcomponents of the at least two functional solutions.

3. A user interface according to claim 1, further comprising a pop-up window generated from an active region of the display area for performing an operation.

4. A user interface according to claim 1, wherein the functional solutions include configuration information and run-time information.
